(19) United States
(12) Patent Application Publication
(10) Pub. No.: US 2011/0146711 A1
(43) Pub. Date: Jun. 23, 2011

(54) APPARATUS AND METHOD FOR CLEANING CULVERTS

(76) Inventors: Howard J. GILLS, Cartersville, VA (US); Robert H. Gills, Cartersville, VA (US)

(21) Appl. No.: 12/974,412

(22) Filed: Dec. 21, 2010

Related U.S. Application Data
(60) Provisional application No. 61/289,067, filed on Dec. 22, 2009.

(51) Int. Cl. B08B 9/00

(52) U.S. Cl. 134/8; 15/104.095

(57) ABSTRACT

An apparatus and method for cleaning culverts or pipes employing an extendable mechanism for generally horizontal cleaning of a culvert or pipe that might be blocked by debris. The apparatus may be powered by tractor-like devices and insertable into a debris filled culvert or pipe and rotated to dislodge debris. The apparatus may include one or more tines or screw-like blade that bites into and dislodges debris. A pull-out device and brush tool is also provided.

This application claims priority and benefit of U.S. Provisional Application No. 61/289,067 filed Dec. 22, 2009, the disclosure of which is incorporated by reference herein in its entirety.

### BACKGROUND

1. Field of the Invention

This invention relates generally to an apparatus and method for cleaning culverts and, more particularly, to an apparatus and method for cleaning culverts using a horizontally oriented powered auger.

2. Related Art

Culverts are generally employed to provide a channel to permit e or passageways under roadways. However, over time, these culverts may become obstructed with debris and the operational purpose of the culvert inhibited.

The cost for clearing these culverts has been rather large due to the techniques currently available, such techniques often use water or pressurized water and often are inadequate for difficult obstructions. Moreover, the cost of such equipment is significant.

### BRIEF DESCRIPTION OF THE DRAWINGS

The accompanying drawings, which are included to provide a further understanding of the invention, are incorporated in and constitute a part of this specification, illustrate embodiments of the invention, and together with the detailed description, serve to explain the principles of the invention. No attempt is made to show structural details of the invention in more detail than may be necessary for a fundamental understanding of the invention and the various ways in which it may be practiced. In the drawings:

FIGS. 1A and 1B are illustrations in front view and side view of an embodiment of a mountain plate configured according to principles of the invention.

FIGS. 2A and 2B are an illustration of an exemplary rod extension in side view, respectively, configured and end view according to principles of the invention.

FIGS. 3A, 3B, 3C and 3D are exemplary illustrations of end views as labeled and side views of pull-back tools configured according to principles of the invention.

FIGS. 4A and 4B depict exemplary brushes configured according to principles of the invention.

FIGS. 5A and 5B illustrate exemplary auger portions of different lengths configured according to principles of the invention.

FIGS. 6A and 6B illustrate an exemplary double tine auger configured according to principles of the invention.

FIG. 7 is a general block diagram of an illustrative arrangement of using the invention, configured according to principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may he practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

It is understood that the invention is not limited to the particular methodology, devices, apparatus, materials, applications, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the invention.

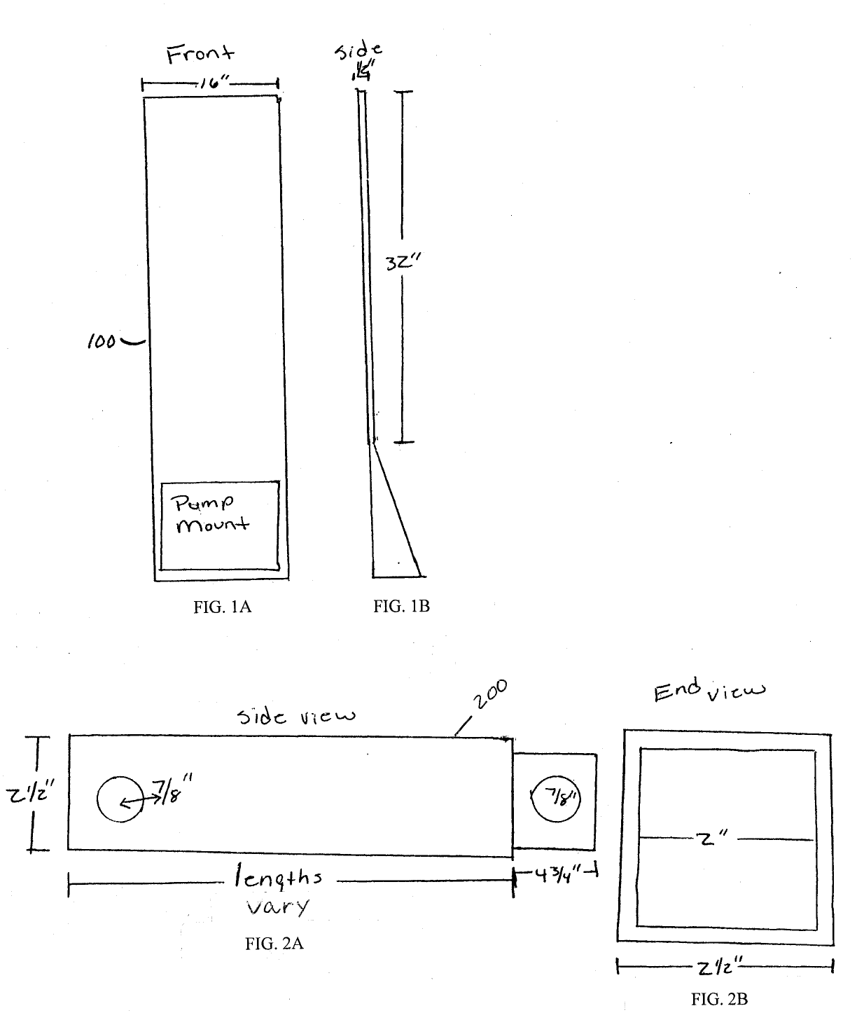

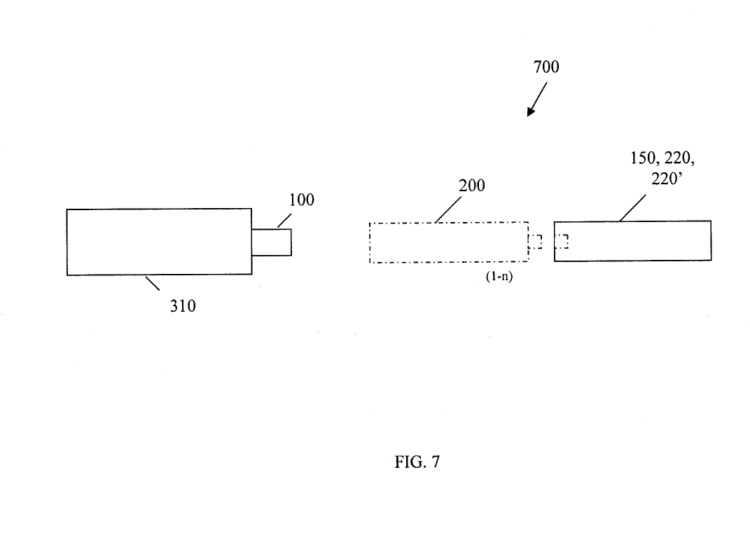

FIGS. 1A and 1B illustrate an exemplary mounting plate in a front view and a side view. The mounting plate 100 provides a mounting mechanism for mounting the auger assembly (e.g., assembly 700 shown in relation to FIG. 7), The mounting plate 100 may be constructed from ½″ steel plate, for example, hut other gauge material and different suitable materials may be employed. The mounting plate 100 may be welded, or otherwise attached, onto standard Caterpillar® adaptor plate (for example) to fit any skid steer loader, or the like. The mounting mechanism 100 may also provide for a hydraulic pump mount.

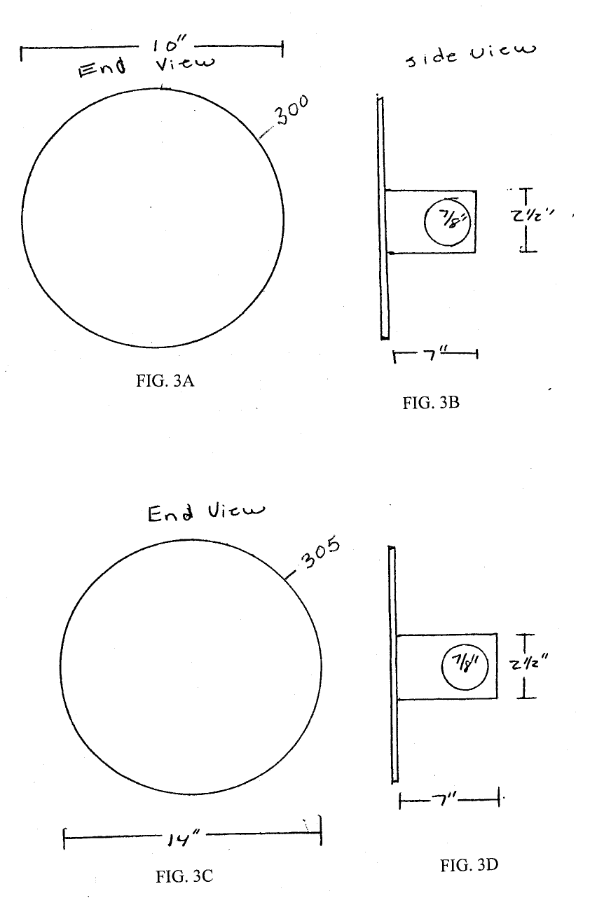

FIGS. 2A and 2B illustrate exemplary rod extensions 200 in a side view and end view. The rod extensions 200 may be built from 2½″ steel tubing, for example, but other sizes and materials may be employed. These rod extensions 200 are interchangeable and may come in a variety of lengths from about 2 ft to about 12 ft determining on length of pipe to be cleaned. One or more lengths of rod extensions 200 may be connected to provide a predetermined length of the overall rod extension for connecting the auger assembly to a hydraulic source for rotation of the rod extension. The rod extensions 200 may be connected to form a rotatable horizontal insertion assembly (e.g., assembly 305, FIG. 7) that includes the auger assembly. The rotatable horizontal insertion assembly may be inserted into a culvert whereby the rotating auger assembly may attack obstructions for removal. The rotatable horizontal insertion assembly may be inserted somewhat at an angle to horizontal as situations dictate, since culverts may not be level.

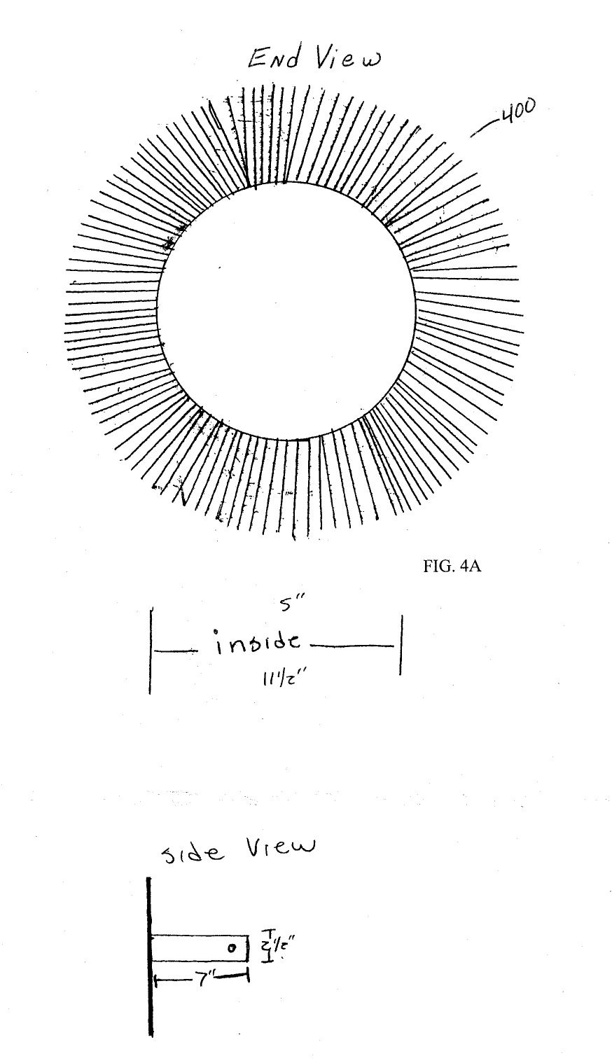

FIGS. 3A, 3B, 3C and 3D are illustrations of end views and side views of pull-back tools that may be connectably attached to the end of the rod extension(s) 200. Pull back tool attachments 300 or 305 may be made from steel plate. A 10″ model 300 may be used for 12″ pipe, a 14″ model 305 may be used for 15″ pipe and larger. They mount on the end of the rod extensions. The pull-back tool attachments 300 or 305 may be used to drag debris from a culvert.

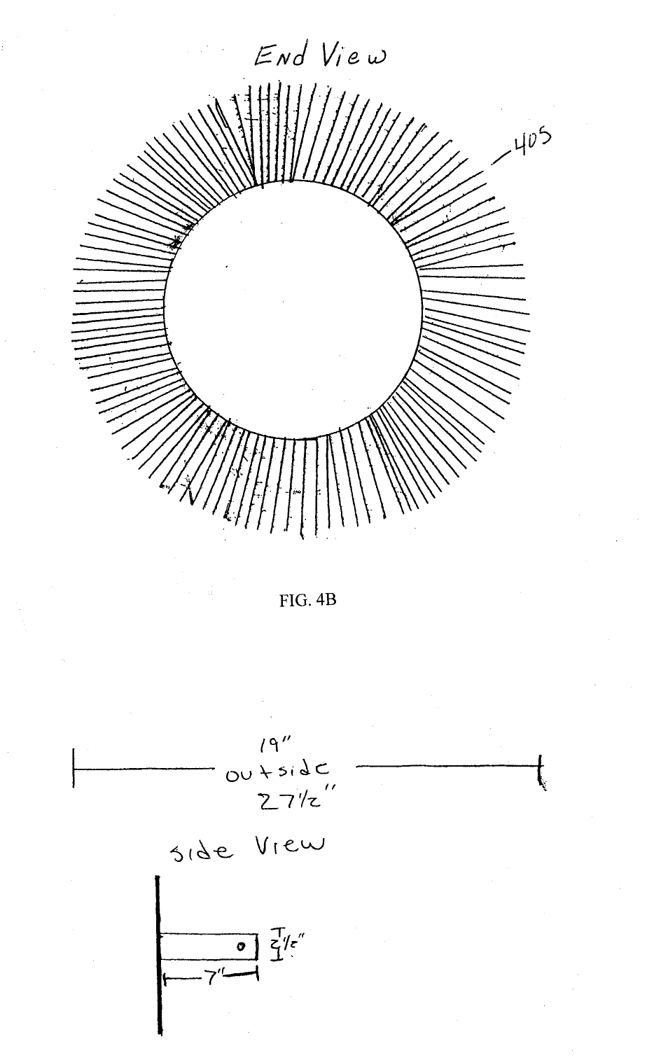

FIGS. 4A and 4B depict brushes 400 and 405 that may be connectably attached to end of extensions to brush out a 12″ pipe (FIG. 4A) or may be used to brush out 15″ pipe or large FIG. 4B). The brushes 400 and 405 clean the inner surfaces of a culvert and typically are rotatable.

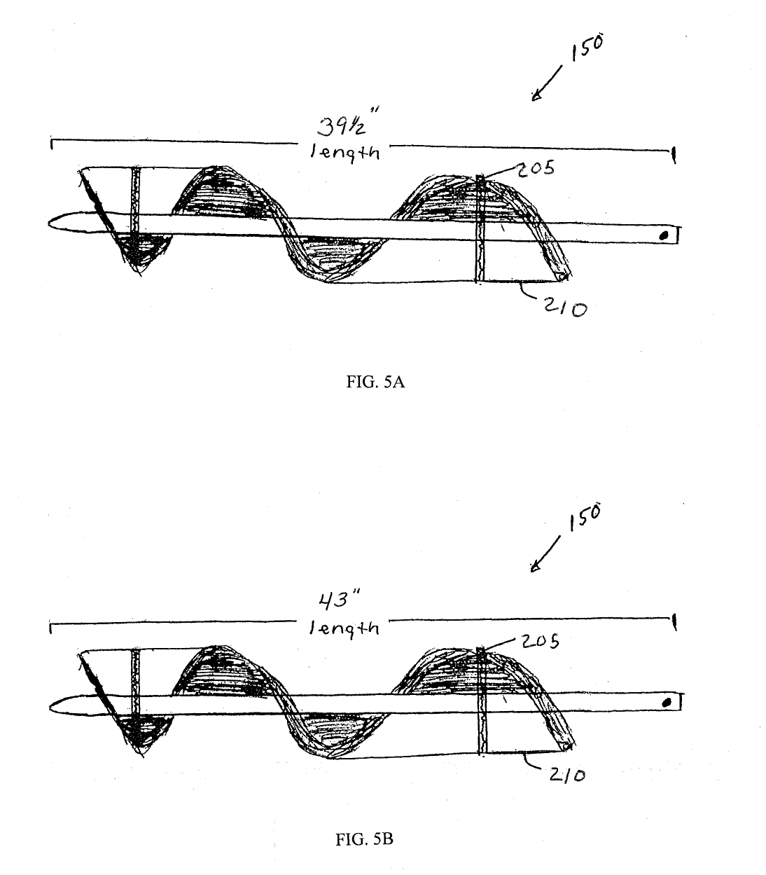

FIGS. 5A and 5B illustrate an exemplary auger portion 150 (FIG. 5A shows one length, FIG. 5B another length) that may be connectably attached to the rod extensions 200 to form an auger assembly (e.g., 305, FIG. 7), the auger portion 150 may be configured with a single tine formed from one end of the auger portion 150 to the other end, and may also include a steel band 205 welded at each end of the auger portion 150. This is to protect the pipe from being hit by the auger edges itself while drilling. Steel plate or rod 210 may hold the bands 205 in place. This auger may also have about 2″ steel bands 205 welded or connected around each end of auger to prevent damage to the pipe while drilling.

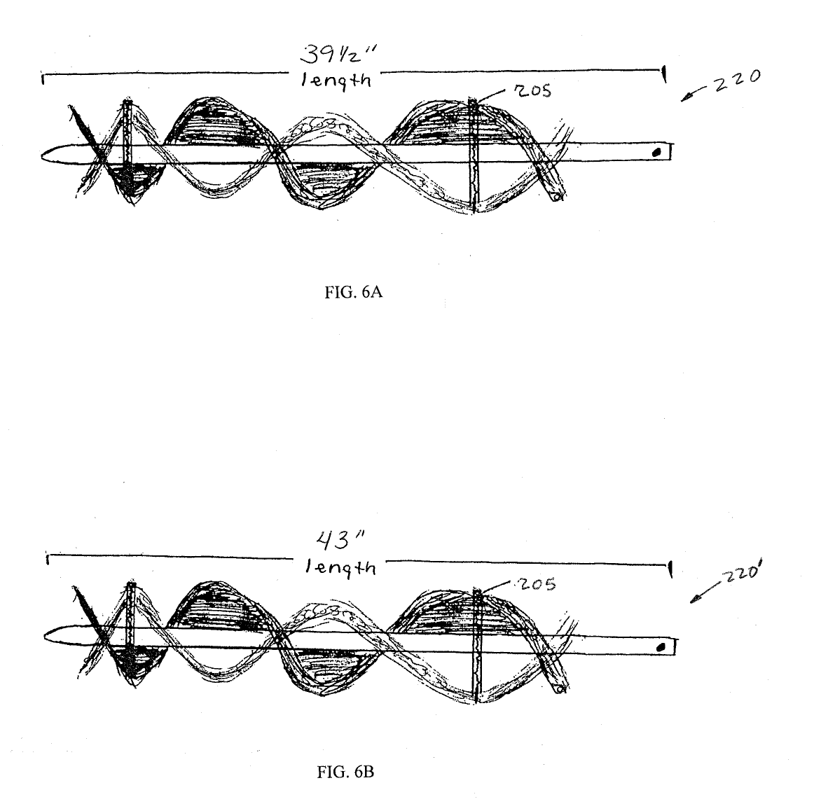

FIGS. 6A and 6B illustrates an exemplary double tine auger portion similar to the auger portion of FIGS. 5A and 5B. These embodiments 220, 220′ show a double-tined or double screw auger portion.

FIG. 7 is a general exemplary configuration 700 for using the invention, according to principles of the invention. A standard A19B Caterpillar® 2 speed hydraulic pump 310 (perhaps part of a tractor or skid loader), for example, may be attached to plate 100. One or more rod extensions 200 may be added as needed for length of pipe to be cleaned. Auger portion 150 (FIGS. 5A or 5B) may be attached at an opposite end of extensions and may be rotated powered by a power source such as pump 310. The power source may be electrical, mechanical, hydraulic, or the like, or combinations thereof. The auger portion 150 may be placed at end of a culvert or pipe and turned-on (rotated). Attachments and auger portion may be moved forward into pipe (by controlling a skid loader or other type of tractor-type device, for example). The rotating auger portion digs out any dirt and debris built up inside pipe. Once the pipe has been cleaned with the auger portion, the auger portion may be removed at entrance end of the culvert or pipe. Then a pull back tool may be attached (see FIG. 3 or 4) depending on size of pipe. This tool may be pulled back through pipe, dragging out any large, loose dirt and debris. Once the pull back tool has been removed from pipe, a brush 400, 405 (see FIG. 4A or 4B) may be attached as determined by size of pipe. A hydraulic pump may be activated, spinning the brush 400, 405 through the pipe (while moving the skid loader or tractor) removing any small dirt or debris. Once brush has been through pipe and back, the culvert or pipe should be clean, and tools may be removed.

Steps for using the invention may include:
Attaching a mounting plate to a tractor type device, such as a skid loader.
Providing hydraulic power (or equivalent power) to an auger assembly, the auger assembly may comprise one or more extension rods and an auger portion, the number of extension rods depending on the pre-determined length of each rod and the length of any pipe or culvert to be cleaned. The auger portion may be selected to be sized for the diameter of the pipe or culvert to be cleaned.
Rotating the auger assembly and moving the auger assembly horizontally along a pipe or culvert to dislodge debris.
Optionally removing the auger portion and replace with a pull back tool to pull debris from inside the pipe or culvert. The brush may be selected based on a diameter of the pipe or culvert
Optionally removing the pull back tool (or auger portion, if appropriate) and placing a brush assembly on the rod extensions to brush the inside of the pipe or culvert by rotating the brush along the length of the pipe or culvert. The length of culverts may have various lengths, such as 8 feet, 12 feet, 20 feet, or more, for example.

While the invention has been described in terms of embodiments, those skilled in the art will recognize that the invention can he practiced with modifications and in the spirit and scope of the appended claims.

We claim:

1. An apparatus for cleaning culverts, comprising:
a rotatable and detachable auger configured to be positioned horizontally inside a pipe;
a power source for detachably connecting to and rotating the auger inside the pipe; and
a mechanism for moving the auger horizontally through the pipe for cleaning the pipe.

2. The apparatus of claim 1, wherein the power source is a hydraulic power source.

3. The apparatus of claim 1, wherein the auger has at least one set of tines or screw type blade.

4. The apparatus of claim 1, wherein the auger is connectable to at least one extension rod.

5. The apparatus of claim 1, wherein the rotatable and detachable auger is replaceable by a cleaning brush mechanism.

6. The apparatus of claim 1, wherein the rotatable and detachable auger is replaceable by a pull back.

7. An apparatus for cleaning pipes in culverts or pipe oriented in a generally horizontal manner comprising:
means for cleaning a culvert or pipe; and
means for extending a length of the means for cleaning a culvert or pipe, the means for extending connectable to the means for cleaning.

8. The apparatus of claim 7, wherein the means for extending extends in predetermined lengths.

9. A method for cleaning a culvert or pipe, comprising:
inserting an auger into a culvert or pipe;
rotating the auger; and
moving the auger into culvert or pipe,
wherein the rotating auger is configured to remove debris within the culvert or pipe, and wherein the auger is extendable in length.

10. The method of claim 9, wherein the attaching step, the auger assembly comprises at least one screw type blade.

11. The method of claim 9, further comprising the step of extending the length of the auger for extending the auger further into the culvert or pipe.

12. The method of claim 9, further comprising replacing the auger with a debris extraction device for dragging debris from the culvert or pipe.

13. The method of claim 9, further comprising replacing the auger with a brush for cleaning the pipe or culvert.

14. The method of claim 9, wherein the inserting step inserts the auger horizontally into the culvert or pipe powered by the power drive source.
